(19) United States
(12) Patent Application Publication
(10) Pub. No.: US 2019/0359498 A1
(43) Pub. Date: Nov. 28, 2019

(54) ACTIVE MATERIAL PRECURSOR AND METHOD OF PREPARING THE SAME

(71) Applicant: SAMSUNG SDI CO., LTD., Yongin-si (KR)

(72) Inventors: Joong-Ho Moon, Yongin-si (KR); Do-Hyung Park, Yongin-si (KR); Min-Han Kim, Yongin-si (KR); Ji-Hyun Kim, Yongin-si (KR); Seon-Young Kwon, Yongin-si (KR); Kyoung-Hyun Kim, Yongin-si (KR)

(21) Appl. No.: 16/534,754

(22) Filed: Aug. 7, 2019

Related U.S. Application Data
(62) Division of application No. 14/624,519, filed on Feb. 17, 2015.

(30) Foreign Application Priority Data
May 20, 2014 (KR) 10-2014-0060489

(51) Int. Cl. C01G 53/00; H01M 4/525; H01M 4/505; H01M 10/052; C01G 45/12

(52) U.S. Cl. CPC C01G 53/50; C01G 53/006; H01M 4/525; H01M 4/505; C01G 53/40; C01P 2006/11; C01G 45/1257; H01M 2220/30; C01P 2004/03; C01P 2006/40; C01P 2002/72; H01M 10/052

(57) ABSTRACT

An active material precursor having a hollow structure is represented by Formula 1:

NiₐMn_{b}Co_{c}M_{d}(OH)₂ Formula 1
where, in Formula 1, 0<a≤1, 0<b≤1, 0<c≤1, 0≤d≤1, and a+b+c=1; and M is at least one metal selected from the group consisting of titanium (Ti) vanadium (V), chromium (Cr), iron (Fe), copper (Cu), aluminum (Al), magnesium (Mg), zirconium (Zr), and boron (B). A method of the active material precursor includes: mixing a nickel precursor, a manganese precursor, a cobalt precursor, a metal (M) precursor, and a solvent to prepare a precursor mixture; and mixing the precursor mixture and a pH adjusting agent to adjust a pH value of the resultant to be in a range of about 11.0 to about 11.2.

### CROSS-REFERENCE TO RELATED APPLICATIONS

This application is a divisional of U.S. patent application Ser. No. 14/624,519, filed on Feb. 17, 2015, which claims priority to and the benefit of Korean Patent Application No. 10-2014-0060489, filed on May 20, 2014, in the Korean Intellectual Property Office, the entire content of which is incorporated herein by reference.

### BACKGROUND

### 1. Field

Aspects of one or more embodiments of the present invention are directed toward an active material precursor and a method of preparing the same.

### 2. Description of the Related Art

In recent years, use of lithium secondary batteries in mobile phones, camcorders, and laptop computers has increased rapidly. A factor that influences a capacity of a lithium secondary battery is a cathode active material. Additionally, the long-term usability of a lithium secondary battery at high rates and the ability to maintain initial capacity over many charge/discharge cycles depends on the electrochemical characteristics of the cathode active material.

Lithium nickel composite oxides, as well as lithium cobalt oxides, have been widely used (utilized) as cathode active materials for lithium secondary batteries.

A transition metal may be added to a lithium nickel composite oxide to improve stability and cycle properties of a lithium secondary battery.

However, an electrode density and a capacity of related art lithium nickel composite oxides may still be improved.

### SUMMARY

Aspects of one or more embodiments of the present invention are directed toward an active material precursor and a method of preparing the active material precursor.

Additional aspects will be set forth in part in the description which follows and, in part, will be apparent from the description, or may be learned by practice of the embodiments presented herein.

According to one or more embodiments of the present invention, a hollow active material precursor is represented by Formula 1.

NiₐMn_{b}Co_{c}M_{d}(OH)₂ Formula 1

In Formula 1, 0<a≤1, 0<b≤1, 0<c≤1, 0≤d≤1, and a+b+c=1.

In Formula 1, M is at least one metal selected from titanium (Ti) vanadium (V), chromium (Cr), iron (Fe), copper (Cu), aluminum (Al), magnesium (Mg), zirconium (Zr), and boron (B).

One or more embodiments of the present invention are directed toward a method of preparing a hollow active material precursor represented by Formula 1, the method including: mixing a nickel precursor, a manganese precursor, a cobalt precursor, a metal (M) precursor, and a solvent to obtain a precursor mixture; and mixing the precursor mixture and a pH adjusting agent to adjust a pH value of the resultant to be in a range of about 11.0 to about 11.2.

NiₐMn_{b}Co_{c}M_{d}(OH)₂ Formula 1

In Formula 1, 0<a≤1, 0<b≤1, 0<c≤1, 0≤d≤1.

In Formula 1, M is at least one metal selected from titanium (Ti) vanadium (V), chromium (Cr), iron (Fe), copper (Cu), aluminum (Al), magnesium (Mg), zirconium (Zr), and boron (B).

Another embodiment is directed toward a hollow active material formed from the active material precursor.

### BRIEF DESCRIPTION OF THE DRAWINGS

These and/or other aspects of the present disclosure will become apparent and more readily appreciated from the following description when considered together with the accompanying drawings in which:

FIG. 1 is a schematic view of a lithium secondary battery according to an embodiment of the present invention;

FIG. 2 is a scanning electron microscope (SEM) image of an active material precursor prepared according to Example 1;

FIG. 3 is an SEM image of an active material precursor prepared according to Comparative Example 1;

FIG. 4 is an SEM image of an active material prepared according to Example 3; and

FIG. 5 is an SEM image of an active material prepared according to Comparative Example 3.

### DETAILED DESCRIPTION

Reference will now be made in more detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. Expressions such as “at least one of,” when preceding a list of elements, modify the entire list of elements and do not modify the individual elements of the list. Further, the use of “may” when describing embodiments of the present invention refers to “one or more embodiments of the present invention.” Also, in the context of the present application, when a first element is referred to as being “on” a second element, it can be directly on the second element or be indirectly on the second element with one or more intervening elements interposed therebetween.

According to an embodiment of the present invention, a hollow active material precursor is represented by Formula 1.

NiₐMn_{b}Co_{c}M_{d}(OH)₂ Formula 1

In Formula 1, 0<a≤1, 0<b≤1, 0<c≤1, 0≤d≤1, and a+b+c=1.

In Formula 1, M is at least one metal selected from the group consisting of titanium (Ti) vanadium (V), chromium (Cr), iron (Fe), copper (Cu), aluminum (Al), magnesium (Mg), zirconium (Zr), and boron (B).

In Formula 1, a may be, for example, from about 0.22 to about 0.70 (e.g., 0.22≤a≤0.70); b may be, for example, from about 0.15 to about 0.66 (e.g., 0.15≤b≤0.66) or, in particular, from about 0.25 to about 0.40 (e.g., 0.25≤b≤0.40); and c may be, for example, from about 0.12 to about 0.30 (e.g., 0.12≤c≤0.30). As used herein, the term “hollow” refers to a structure having an empty (or open) internal space (e.g., a structure having a cavity or a plurality of cavities). For example, the hollow active material precursor disclosed herein may have an open space at least partially surrounded by a material of the hollow active material precursor.

A tap density of the active material precursor is about 1.95 g/ml or less, for example, from about 1.5 g/ml to about 1.9 g/ml.

In Formula 1, M may be combined with Ni, Mn, and Co. A primary particle diameter of the active material precursor may be from about 1 μm to about 2 μm. For example, a thickness of the active material precursor may be about 100 nm, and the active material precursor may have a long rod shape.

The active material precursor is a starting material that is used (utilized) to form an active material represented by Formula 3 of Formula 3′. When the active material precursor is used (utilized), an active material having a hollow structure having an empty (or open) interior (e.g., a cavity or a plurality of cavities) may be obtained, and a cathode for a lithium secondary battery having an increased capacity and improved initial efficiency characteristics and a lithium secondary battery including the cathode may be manufactured.

xLi₂MnO₃-(1-x)Li_{y}MO₂ Formula 3

xLi₂MnO₃-(1-x)Li_{y}NiₐMn_{b}Co_{c}M_{d}O₂ Formula 3′

In Formula 3, 0<x≤0.8 and 1.0≤y≤1.05. In Formula 3′, 0<x≤0.8; 1.0≤y≤1.05; 0<a≤1, 0<b≤1, 0<c≤1, 0≤d<1 and a+b+c+d=1.

In Formula 3, M is at least one metal selected from the group consisting of Ti, V, Cr, Mn, Fe, Co, Ni, Cu, Al, Mg, Zr, and B. In Formula 3′, M is at least one metal selected from the group consisting of Ti, V, Cr, Fe, Cu, Al, Mg, Zr, and B

In an X-ray diffraction (XRD) spectrum using (utilizing) Cu-Kα radiation, the active material represented by Formula 3 or Formula 3′ has a singlet peak that is observed at a 2θ angle of 21±0.5.

The active material precursor represented by Formula 1 may include a compound that is represented by Formula 2 (e.g., d in Formula 1 is equal to 0).

NiₐMn_{b}Co_{c}(OH)₂ Formula 2

In Formula 2, 0<a<1, 0<b<1, 0<c<1, and a+b+c=1.

In Formula 2, a may be from about 0.22 to about 0.70 (e.g., 0.22≤a≤0.70); b may be from about 0.15 to about 0.66 (e.g., 0.15≤a≤0.66); and c may be from about 0.12 to about 0.30 (e.g., 0.12≤a≤0.30).

The active material precursor represented by Formula 2 may include, for example, Ni_{0.30}Co_{0.30}Mn_{0.40}(OH)₂, Ni_{0.27}Co_{0.27}Mn_{0.47}(OH)₂, Ni_{0.265}Co_{0.265}Mn_{0.47}(OH)₂, Ni_{0.40}Co_{0.16}Mn_{0.44}(OH)₂, Ni_{0.45}Co_{0.18}Mn_{0.37}(OH)₂, Ni_{0.48}Co_{0.16}Mn_{0.36}(OH)₂, or Ni_{0.54}Co_{0.18}Mn_{0.28}(OH)₂. In an XRD spectrum using (utilizing) Cu-Kα radiation, a peak is observed at a 2θ angle of 35±0.5°, which corresponds to the active material according to an embodiment of the present invention.

The active material represented by Formula 3 or Formula 3′ may include, for example, a compound represented by Formula 4 (e.g., d in Formula 1 is equal to 0).

xLi₂MnO₃-(1-x)Li_{y}NiₐMn_{b}Co_{c}O₂ Formula 4

In Formula 4, 0<x≤0.8 and 1.0≤y≤1.05; 0<a≤1, 0<b≤1, 0<c≤1, and a+b+c=1.

The compound represented by Formula 4 may be, for example, 0.2Li₂MnO₃-0.8LiNi_{0.5}Co_{0.2}Mn_{0.3}O₂.

In an XRD spectrum using (utilizing) Cu-Kα radiation, the active material according to an embodiment of the present invention has a singlet peak that is observed at a 2θ angle of 21±0.5°. In a transmission electron microscope analysis of the active material, phases of a shell region and a face region of the active material have an identical (or substantially identical) diffraction pattern.

Hereinafter, embodiments of the active material precursor of Formula 1 and a method of preparing an active material represented by Formula 3 or Formula 3′ from the active material precursor will be described in more detail.

The active material represented by Formula 3 or Formula 3′ may be obtained by mixing the active material precursor of Formula 1 and a lithium precursor to form a mixture, mixing the mixture with a lithium compound, and heat-treating the resultant.

The lithium precursor may be a lithium hydroxide, a lithium fluoride, a lithium carbonate, or a mixture thereof. The amount of the lithium compound may be stoichiometrically controlled to obtain the active material of Formula 3 or Formula 3′. For example, stoichiometric amounts of the lithium precursor and the active material precursor of Formula 1 may be mixed.

The heat-treating of the resultant may be performed at a temperature in a range of about 700° C. to about 900° C. When the heat-treating temperature is performed within the foregoing range, the forming of the active material may be facilitated.

The heat-treating of the resultant may be performed under (or in) an inert gas atmosphere. The inert gas atmosphere may be formed by using (utilizing) nitrogen gas or argon gas.

The active material precursor represented by Formula 1 may be prepared by mixing a nickel precursor, a manganese precursor, a cobalt precursor, optionally, a metal (M) precursor, and a solvent; and adding a pH adjusting agent to obtain a mixture. Here, the metal (M) precursor is a precursor including at least one metal selected from the group consisting of Ti, V, Cr, Fe, Cu, Al, Mg, Zr, and B.

Examples of the M precursor may include an M sulfate, an M nitrate, and an M chloride.

Examples of the nickel precursor may include a nickel sulfate, a nickel nitrate, and a nickel chloride. Examples of the cobalt precursor may include a cobalt sulfate, a cobalt nitrate, and a cobalt chloride.

Examples of the manganese precursor may include a manganese sulfate, a manganese nitrate, and a manganese chloride.

The amount of the nickel precursor, the manganese precursor, the cobalt precursor, and the M precursor may be stoichiometrically controlled to obtain the active material precursor of Formula 1. For example, stoichiometric amounts of the nickel precursor, the manganese precursor, the cobalt precursor, and the M precursor may be mixed.

Examples of the solvent may include ethanol and propanol. The amount of the solvent may be from about 100 parts to about 3000 parts by weight, based on 100 parts by weight of the nickel precursor. When the amount of the solvent is within the foregoing range, each composition (each of the precursors) of the mixture may be homogeneously mixed.

Examples of the pH adjusting agent may include at least one selected from a sodium hydroxide, a potassium hydroxide, and a lithium hydroxide or an aqueous solution thereof.

A pH of the resultant may be adjusted to be in a range of about 11.0 to about 11.2 by controlling the amount of the pH adjusting agent. When a pH of the resultant is within the foregoing range, an active material precursor having a hollow structure may be obtained.

A chelating agent may also be added to the mixture. The chelating agent reacts with the nickel precursor, the cobalt precursor, the manganese precursor, and/or the metal (M) precursor to form a chelated-form of the corresponding precursor and controls reactivity of the metal (e.g., the reactivity of the nickel, cobalt, manganese, or M).

Examples of the chelating agent may be at least one selected from ammonia water, acetyl acetone, ethylenediaminetetraacetic acid (EDTA), and benzoylacetone (BzAc).

The amount of the chelating agent may be from about 0.1 mole to about 3 moles based on 1 mole of a nickel-containing precursor. When an amount of the chelating agent is within the foregoing range, the reactivity of the metal may be appropriately controlled, and thus a nickel composite hydroxide having a desired density, particle diameter characteristics, and composition deviation may be obtained.

A precipitate is obtained from the resultant, and then the precipitate is washed with pure water and dried, thereby preparing an active material precursor that is represented by Formula 1 and has a hollow structure.

Hollow properties of the active material precursor may be confirmed by measuring a pallet density and a tap density of the active material precursor.

The active material represented by Formula 3 or Formula 3′ according to an embodiment of the present invention may be used (utilized) as a cathode active material for a lithium secondary battery.

When the active material is used (utilized) in an electrode, an electrode having an increased density and improved capacity characteristics may be prepared, and when the electrode is used (utilized) in a lithium secondary battery, a lithium secondary battery having improved life characteristics may be manufactured.

Hereinafter, a process of preparing a lithium secondary battery including the active material as a cathode active material for a lithium battery will be described in more detail. Also, according to another embodiment of the present invention, a method of preparing a lithium secondary battery including a cathode, an anode, a lithium salt-containing non-aqueous electrolyte, and a separator will be described.

The cathode and the anode are manufactured by coating and drying a composition for forming a cathode active material layer (hereinafter, also referred to as “a cathode active material layer composition”) and a composition for forming an anode active material layer (hereinafter, also referred to as “an anode active material layer composition”) on a current collector, respectively.

The composition for forming a cathode active material layer is prepared by mixing a cathode active material, a conducting agent, a binder, and a solvent, where the cathode active material may include the active material represented by Formula 3 or Formula 3′.

The binder includes a composition that helps bonding the active material and the conducting agent to one another and/or to the current collector. An amount of the binder may be from about 1 part to about 50 parts by weight, based on 100 parts by weight of the total weight of the cathode active material. Non-limiting examples of the binder include polyvinylidene fluoride, polyvinyl alcohol, carboxymethyl cellulose (CMC), starch, hydroxypropyl cellulose, reproduced cellulose, polyvinylpyrrolidone, tetrafluoroethylene, polyethylene, polypropylene, ethylene-propylene-diene terpolymer (EPDM), sulfonated EPDM, styrene butadiene rubber, fluorinated rubber, and various suitable copolymers. The amount of the binder may be from about 2 parts to about 5 parts by weight, based on 100 parts by weight of the total weight of the cathode active material. When the amount of the binder is within any of the foregoing ranges, an active material layer may have an excellent bonding strength to be bonded to the current collector.

The conducting agent may be any suitable conductive material that does not cause chemical changes (e.g., an undesirable chemical change) in a battery. Examples of the conductive material may include graphite, such as natural graphite or artificial graphite; carbonaceous materials, such as carbon black, acetylene black, Ketjen black, channel black, furnace black, lamp black, or summer black; conducting fibers, such as carbonaceous fibers or metal fibers; metal powder, such as carbon fluoride powders, aluminum powders, or nickel powders; conducting whiskers, such as zinc oxide or potassium titanate; and conducting metal oxides such as a titanium oxide; and conducting materials such as polyphenylene derivatives.

The amount of the conducting agent may be from about 2 parts to about 5 parts by weight, based on 100 parts by weight of the total weight of the cathode active material. When the amount of the conducting agent is within the foregoing range, an electrode that is finally obtained therefrom has excellent conducting characteristics.

A non-limiting example of the solvent may include N-methylpyrrolidone.

The amount of the solvent may be from about 1 part to about 10 parts by weight, based on 100 parts by weight of the cathode active material. When the amount of the solvent is within the foregoing range, the forming of the active material layer may be facilitated.

A cathode current collector may have a thickness of about 3 μm to about 500 μm. Any suitable material that does not cause chemical changes (e.g., an undesirable chemical change) in a battery and has high conductivity may be used (utilized) to form the cathode current collector. Examples of the material for forming the cathode current collector may include stainless steel, aluminum, nickel, titanium, aluminum, or a stainless steel support that is surface-treated with carbon, nickel, titanium, or silver. The cathode current collector may have a corrugated surface to increase a bonding strength of the cathode active material to the cathode current collector. The cathode current collector may take various suitable forms, such as a film, a sheet, a foil, a net, a porous product structure, foam, or non-woven fabric.

Separate from the cathode active material layer composition prepared above, the composition for forming an anode active material layer is prepared using (utilizing) an anode active material, a binder, a conducting agent, and a solvent together.

The anode active material may be a material that allows intercalation and deintercalation of lithium ions. Non-limiting examples of the anode active material include graphite; carbonaceous material, such as carbon; lithium and alloys thereof; and silicon oxide-based materials. In one embodiment, the anode active material may be silicon oxide.

The amount of the binder may be from about 1 part to about 50 parts by weight, based on 100 parts by weight of the total weight of the anode active material. Non-limiting examples of the binder are the same as those described in connection with the cathode.

The amount of the conducting agent may be from about 1 part to about 5 parts by weight, based on 100 parts by weight of the total weight of the anode active material. When the amount of the conducting agent is within the foregoing range, an electrode that is finally obtained therefrom may have excellent conducting characteristics.

The amount of the solvent may be from about 1 part to about 10 parts by weight, based on 100 parts by weight of the total weight of the anode active material. When the amount of the solvent is within the foregoing range, the forming of the anode active material layer may be facilitated.

Non-limiting examples of the conducting agent and the solvent are the same as those described in connection with the cathode.

The anode current collector may have a thickness of about 3 μm to about 500 μm. The anode electrode current collector is not particularly limited, and any suitable conductive material that does not cause chemical changes (e.g., an undesirable chemical change) in a battery may be used (utilized). Examples of the conductive material may include copper, stainless steel, aluminum, nickel, titanium, heat-treated carbon, a copper or stainless steel support that is surface-treated with carbon, nickel, titanium, or silver, or an aluminum-cadmium alloy. Also, like the cathode current collector, the anode current collector may have a corrugated surface to increase a bonding strength of the anode active material to the anode current collector. The anode collector may take various suitable forms, such as a film, a sheet, a foil, a net, a porous product structure, foam, or non-woven fabric.

The separator is disposed between the cathode and the anode, each of which may be prepared in the manner described above.

The separator may have a pore diameter of about 0.01 μm to about 10 μm and a thickness of about 5 μm to about 300 μm in general. Examples of the separator may include olefin-based polymers, such as polypropylene or polyethylene; a glass fiber sheet; and non-woven fabric. When a solid electrolyte, such as a polymer, is used (utilized) as an electrolyte, the solid electrolyte may serve as a separator instead of, or in addition to, the above-described separators.

The lithium salt-containing non-aqueous electrolyte includes a non-aqueous electrolyte and a lithium salt. Examples of the non-aqueous electrolyte may include a non-aqueous electrolyte solution, an organic solid electrolyte, and an inorganic solid electrolyte.

Non-limiting examples of the non-aqueous electrolyte solution may include aprotic organic solvents (such as N-methyl-2-pyrrolidone, propylene carbonate, ethylene carbonate (EC), butylene carbonate, dimethyl carbonate, diethyl carbonate (DEC), γ-butyrolactone, 1,2-dimethoxy ethane, 2-methyl tetrahydrofuran, N,N-dimethylsulfoxide, 1,3-dioxolane, N,N-formamide, N,N-dimethylformamide, dioxolane, acetonitrile, nitromethane, methyl formate, methyl acetate, phosphoric acid triester, trimethoxy methane, dioxolane derivatives, sulfolane, methyl sulfolane, 1,3-dimethyl-2-imidazolidinone, propylene carbonate derivatives, tetrahydrofuran derivatives, ether, methyl propionate, and/or ethyl propionate).

Non-limiting examples of the organic solid electrolyte may include polyethylene derivatives, polyethylene oxide derivatives, polypropylene oxide derivatives, phosphoric acid ester polymers, polyvinyl alcohols, and polyvinylidene fluoride. Non-limiting examples of the organic solid electrolyte may include nitrides, halides, and sulfates of lithium such as Li₃N, LiI, Li₅Ni₂, Li₃N—LiI—LiOH, LiSiO₄, LiSiO₄—LiI—LiOH, Li₂SiS₃, Li₄SiO₄, Li₄SiO₄—LiI—LiOH, and Li₃PO₄—Li₂S—SiS₂.

The lithium salt is soluble in the non-aqueous electrolyte. Non-limiting examples of the lithium salt include LiCl, LiBr, LiI, LiClO₄, LiBF₄, LiB₁₀Cl₁₀, LiPF₆, LiCF₃SO₃, LiCF₃CO₂, LiAsF₆, LiSbF₆, LiAlCl₄, CH₃SO₃Li, CF₃SO₃Li, (CF₃SO₂)₂NLi, lithium chloroborate, lithium lower aliphatic carboxylate, lithium tetraphenyl borate, and imide.

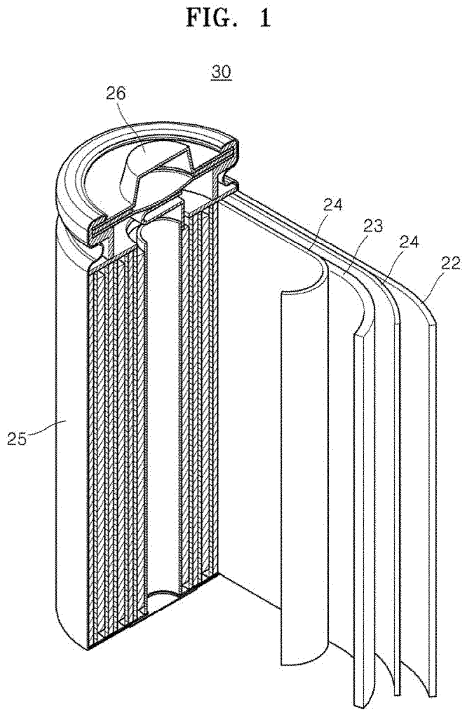

FIG. 1 is a cross-sectional view schematically illustrating an example structure of a lithium secondary battery 30 according to an embodiment of the present invention.

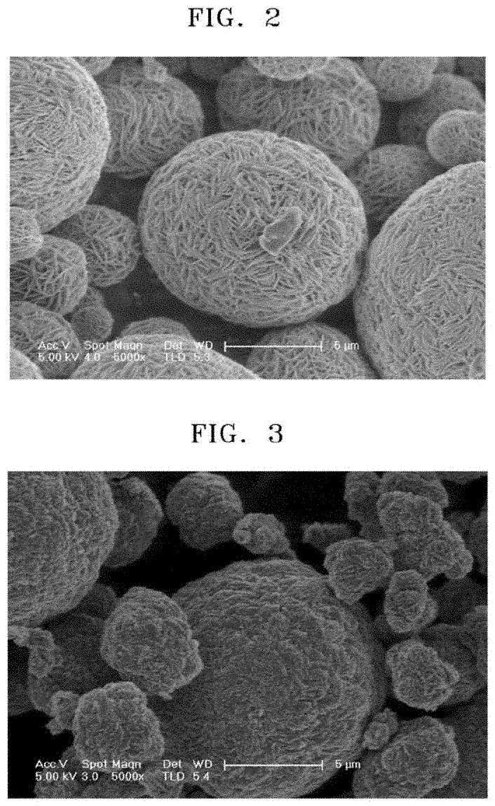

Referring to FIG. 2, the lithium secondary battery 30 includes a cathode 23, an anode 22, a separator 24 disposed between the cathode 23 and the anode 22, an electrolyte that impregnates the cathode 23, the anode 22, and the separator 24, a battery case 25, and a cap assembly 26 that encapsulates the battery case 25. The lithium secondary battery 30 may be assembled by sequentially stacking the cathode 23, the anode 22, and the separator 24, rolling the stack in a spiral shape, and accommodating the rolled-stack in the battery case 25. The battery case 25 is sealed together with the cap assembly 26, thereby completing the lithium secondary battery 30.

Hereinafter, embodiments of the present invention will be described with reference to the following examples. However, the examples are not intended to limit the scope of the present invention.

### Example 1: Preparation of Active Material Precursor

0.36 mole of nickel sulfate as a nickel precursor, 0.14 mole of cobalt sulfate as a cobalt precursor, and 0.40 mole of manganese sulfate as a manganese precursor, were mixed with ammonia water as a chelating agent, to prepare a metal precursor mixture. Here, the amount of the chelating agent may be about 1.25 mole based on 1 mole of the nickel precursor.

The metal precursor mixture was stirred at a rate of about 600 rpm and a temperature maintained at about 50° C. A pH of the metal precursor mixture was adjusted to be about 11.2 by automatically controlling an injection amount of a sodium hydroxide solution.

A precipitate was obtained from the resultant, and the precipitate was washed with pure water and dried to obtain a hollow active material precursor (Ni_{0.40}Co_{0.16}Mn_{0.44}(OH)₂) as a co-precipitate.

### Example 2: Preparation of Active Material Precursor

A hollow active material precursor (Ni_{0.40}Co_{0.16}Mn_{0.44}(OH)₂) was prepared as in Example 1, except that an injection amount of a sodium hydroxide solution was controlled so that a pH of the mixture was adjusted to be about 11.0.

### Example 3: Preparation of Active Material

The metal oxide precursor (Ni_{0.40}Co_{0.16} Mn_{0.44}(OH)₂) prepared as in Example 1 was mixed with 1.2 moles of a lithium carbonate as a lithium precursor, and water was added and mixed thereto to form a mixture. Then, the mixture was heat-treated at a temperature of about 800° C. in an oxidative gas atmosphere including 20 vol % of oxygen and 80 vol % of nitrogen, and thus an active material (0.2Li₂MnO₃-0.8LiNi_{0.5}Co_{0.2} Mn_{0.3}O₂) was obtained.

### Example 4: Preparation of Active Material

An active material (0.2Li₂MnO₃-0.8LiNi_{0.5}Co_{0.2} Mn_{0.3}O₂) was obtained as in Example 3, except that the metal oxide precursor prepared as in Example 2 was used (utilized) instead of the metal oxide precursor prepared as in Example 1.

### Comparative Example 1: Preparation of Active Material Precursor

An active material precursor (Ni_{0.40}Co_{0.16}Mn_{0.44}(OH)₂) was obtained as in Example 1, except that an injection amount of the sodium hydroxide solution was controlled to adjust a pH of the mixture to be about 11.5.

### Comparative Example 2: Preparation of Active Material Precursor

An active material precursor (Ni_{0.40}Co_{0.16}Mn_{0.44}(OH)₂) was obtained as in Example 1, except that an injection amount of the sodium hydroxide solution was controlled to adjust a pH of the mixture to be about 11.5, and an amount of the ammonia water was changed to about 4.5 moles.

### Comparative Example 3: Preparation of Active Material

An active material (0.2Li₂MnO₃-0.8LiNi_{0.5}Co_{0.2}Mn_{0.3}O₂) was obtained as in Example 3, except that the active material precursor prepared as in Comparative Example 1 was used (utilized) instead of the active material precursor prepared as in Example 1.

### Comparative Example 4: Preparation of Active Material

An active material (0.2Li₂MnO₃-0.8LiNi_{0.5}Co_{0.2}Mn_{0.3}O₂) was obtained as in Example 3, except that the active material precursor prepared as in Comparative Example 2 was used (utilized) instead of the active material precursor prepared in Example 1.

### Manufacture Example 1: Manufacture of Coin Half-Cell

A 2032 coin half-cell was manufactured as follows using (utilizing) the active material prepared as in Example 3.

96 g of the active material prepared as in Example 3, 2 g of polyvinylidene fluoride, 47 g of N-methylpyrrolidone as a solvent, and 2 g of carbon black as a conducting agent were mixed together using (utilizing) a mixer, followed by degassing to prepare a uniformly dispersed slurry for forming a cathode active material layer.

An aluminum foil was coated with the slurry thus prepared by using (utilizing) a doctor blade to form a thin electrode plate, which was then dried at a temperature of about 135° C. for about 3 hours or longer, followed by pressing and vacuum drying to manufacture a cathode.

The cathode and a lithium metal counter electrode were assembled into a 2032 type (or kind) coin half-cell. A porous polyethylene (PE) film separator (having a thickness of about 16 μm) was disposed between the cathode and the lithium metal counter electrode, and the 2032 type (or kind) coin half-cell was manufactured via injection of an electrolytic solution.

Here, the injected electrolyte solution was a solution including 1.1 M LiPF₆ dissolved in a solvent mixture of ethylene carbonate (EC) and ethylmethyl carbonate (EMC) in a volume ratio of 3:5.

### Manufacture Example 2: Manufacture of Coin Half-Cell

A coin half-cell was manufactured as in Manufacture Example 1, except that the active material prepared as in Example 4 was used (utilized) instead of the active material prepared as in Example 3.

### Comparative Manufacture Example 1: Manufacture of Coin Half-Cell

A coin half-cell was manufactured as in Manufacture Example 1, except that the active material prepared as in Comparative Example 3 was used (utilized) instead of the active material prepared as in Example 3.

### Comparative Manufacture Example 2: Manufacture of Coin Half-Cell

A coin half-cell was manufactured as in Manufacture Example 1, except that the active material prepared as in Comparative Manufacture Example 4 was used (utilized) instead of the active material prepared as in Example 3.

### Evaluation Example 1: Scanning Electron Microscope (SEM) Analysis

### 1) Active Material Precursor

The active material precursor prepared as in Example 1 and the active material precursor prepared as in Comparative Example 1 were analyzed using (utilizing) a scanning electron microscope (SEM). The results are shown in FIGS. 2 and 3, respectively.

Referring to FIG. 2, it was confirmed that the active material precursor (metal hydroxide) prepared as in Example 1 has a loose structure as compared to the active material precursor prepared in Comparative Example shown in FIG. 3.

### 2) Active Material

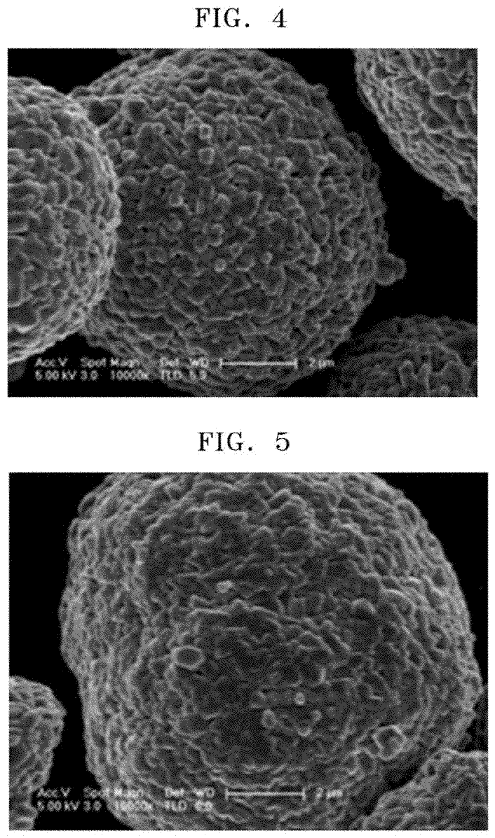

The active material prepared as in Example 3 and the active material prepared as in Comparative Example 3 were analyzed using (utilizing) an SEM. The results are shown in FIGS. 4 and 5, respectively.

### Evaluation Example 2: Tap Density

Tap densities of the active material precursors of Examples 1 and 2 and Comparative Examples 1 and 2 were measured. The results are shown in Table 1.

Each tap density was measured by using (utilizing) a tap density meter, filling a mass cylinder with a set or predetermined amount of each of the active materials, and tapping the active material 500 times or more with a constant force. The tap density was calculated by evaluating a volume and a weight of the active material.

TABLE 1

| Example | Tap density (g/ml) |
|---|---|
| Example 1 | 1.95 |
| Example 2 | 1.84 |
| Comparative Example 1 | 2.1 |
| Comparative Example 2 | 2.4 |

### Evaluation Example 3: Charge-Discharge Test

Charge-discharge characteristics of the coin half-cells prepared as in Manufacture Example 1 and Comparative Manufacture Example 1 were evaluated using (utilizing) a charger/discharger (TOYO-3100, available from TOYO System Co. Ltd). The results are shown in Table 2.

Each of the coin half-cells prepared in Manufacture Example 1 and Comparative Manufacture Example 1 was subjected to one cycle of charging and discharging at 0.1C rate for formation, followed by one cycle of charging and discharging at 0.2C. Afterward, initial charge-discharge characteristics of the coin half-cell were evaluated. After a further 50 cycles of charging and discharging at 1C rate, cycle characteristics of the coin half-cell were evaluated. The charging was set to start at a constant current (CC) mode, and then was shifted to a constant voltage (CV) mode to cut off at 0.01C, and the discharging was set to cut off at 1.5V in a CC mode.

### (1) Initial Charge and Discharge Efficiency (I.C.E.)

Initial charge and discharge efficiency (I.C.E.) of each of the coin half-cells was calculated using (utilizing) Equation 1.

I.C.E. (%)=[Discharge capacity at 1^{st} cycle/Charge capacity at 1^{st} cycle]×100 [Equation 1]

### (2) Charge Capacity and Discharge Capacity

A charge capacity and a discharge capacity at the 1^{st} cycle of each of the coin half-cells was measured. The results are shown in Table 2.

TABLE 2

| | Charge | Discharge | |
|---|---|---|---|
| | capacity | capacity | |
| Example | (mAh/g) | (mAh/g) | I.C.E. (%) |
| Comparative | 196.9 | 166.4 | 84.5 |
| Manufacture | | | |
| Example 1 | | | |
| Manufacture | 195.1 | 173.1 | 88.7 |
| Example 1 | | | |

Referring to Table 2, the half coin-cell prepared in Manufacture Example 1 had a higher I.C.E. as compared to that of the half coin-cell prepared in Comparative Manufacture Example 1.

An active material represented by the Formula 3 is easily prepared using the active material precursor according to embodiments of the present invention. When the active material is included in a lithium secondary battery, a capacity and initial efficiency characteristics of the lithium secondary battery may be improved.

It should be understood that the example embodiments described herein should be considered in a descriptive sense only and not for purposes of limitation. Descriptions of features or aspects within each embodiment should typically be considered as available for other similar features or aspects of other embodiments.

While one or more embodiments of the present invention have been described with reference to the figures, it will be understood by those of ordinary skill in the art that various changes in form and details may be made without departing from the spirit and scope of the present invention as defined by the following claims, and equivalents thereof.

What is claimed is:

1. An active material for a battery, wherein the active material is hollow and is formed from an active material precursor comprising:
NiₐMn_{b}Co_{c}M_{d}(OH)₂ Formula 1
wherein, in Formula 1, 0<an For<b≤1, 0<c≤1, 0≤d<1, a+b+c=1; and
M is at least one metal selected from the group consisting of titanium (Ti) vanadium (V), chromium (Cr), iron (Fe), copper (Cu), aluminum (Al), magnesium (Mg), zirconium (Zr), and boron (B).

2. The active material for a battery of claim 1, wherein the active material is represented by Formula 3′:
xLi₂MnO₃-(1-x)Li_{y}NiₐMn_{b}Co_{c}M_{d}O₂ Formula 3′
wherein, in Formula 3′, 0<xn For 1.0n Formu; 0<an Formula 3′, la, 0≤0n and a+b+c+d=1; and
M is at least one metal selected from the group consisting of Ti, V, Cr, Fe, Cu, Al, Mg, Zr, and B.

3. The active material of claim 1, wherein the active material is represented by Formula 4:
xLi₂MnO₃-(1-x)Li_{y}NiₐMn_{b}Co_{c}O₂ Formula 4
wherein, in Formula 4, 0<xn Fo and 1.0d Formu; 0<ad, 0<b≤1, 0<c≤1, and a+b+c=1.

4. The active material precursor of claim 1, wherein a tap density of the active material precursor is about 1.95 g/ml or lower.

5. The active material of claim 1, wherein the active material is 0.2Li₂MnO₃-0.8LiNi_{0.5}Co_{0.2}Mn_{0.3}O₂.

6. The active material of claim 1, wherein the active material precursor is represented by Formula 2:
NiₐMn_{b}Co_{c}(OH)₂ Formula 2
wherein, in Formula 2, 0<a<1, 0.36a 2, ula 2, d, and a+b+c=1.

7. The active material of claim 6, wherein, in Formula 2, a is about 0.22 to about 0.70, b is 0.36 to 0.47, and c is about 0.12 to about 0.30.

8. The active material of claim 1, wherein the active material precursor comprises Ni_{0.30}Co_{0.30}Mn_{0.40}(OH)₂, Ni_{0.265}Co_{0.265}Mn_{0.47}(OH)₂, Ni_{0.265}Co_{0.265}Mn_{0.47}(OH)₂, Ni_{0.40}Co_{0.16}Mn_{0.44}(OH)₂, Ni_{0.45}Co_{0.18}Mn_{0.37}(OH)₂, Ni_{0.48}Co_{0.16}Mn_{0.36}(OH)₂.

9. The active material of claim 1, wherein the active material has a singlet peak that is observed at a 2θ angle of 21ngle.

10. The active material of claim 1, wherein the active material is obtained by a method comprising: mixing the active material precursor of Formula 1 with a lithium precursor to form a mixture, mixing the mixture with a lithium compound, and heat-treating the resultant at a temperature of in a range of about 700° C. to about 900° C., wherein the mixing molar ratio of the lithium precursor to the active material precursor is 2:1:
NiₐMn_{b}Co_{c}M_{d}(OH)₂ Formula 1
wherein, in Formula 1, 0<a≤1, 0<b≤1, 0<c≤1, 0≤d<1, a+b+c+d=1; and
M is at least one metal selected from the group consisting of titanium (Ti) vanadium (V), chromium (Cr), iron (Fe), copper (Cu), aluminum (Al), magnesium (Mg), zirconium (Zr), and boron (B).

11. The active material of claim 1, wherein the active material precursor is obtained by a method comprising:
mixing a nickel precursor, a manganese precursor, a cobalt precursor, a metal (M) precursor, and a solvent to prepare a precursor mixture; and
mixing the precursor mixture and a pH adjusting agent to adjust a pH value of the resultant to be in a range of about 11.0 to about 11.2.

12. The active material of claim 11, wherein a chelating agent is added to the mixing of the precursor mixture and the pH adjusting agent.

13. The active material of claim 12, wherein an amount of the chelating agent is about 0.1 mole to about 3 moles based on 1 mole of the nickel precursor.

14. The active material of claim 12, wherein the chelating agent is at least one selected from the group consisting of ammonia water, acetyl acetone, ethylenediaminetetraacetic acid (EDTA), and benzoylacetone (BzAc).

15. The active material of claim 11, wherein the pH adjusting agent is at least one selected from a sodium hydroxide, a potassium hydroxide, and a lithium hydroxide or an aqueous solution thereof.
